(19) United States
(12) Patent Application Publication
(10) Pub. No.: US 2015/0107732 A1
(43) Pub. Date: Apr. 23, 2015

(54) WHEEL ASSEMBLY WITH FOAM INSERT

(71) Applicant: Deere & Company, Moline, IL (US)

(72) Inventors: STEVEN A. DUPPONG, CEDAR FALLS, IA (US); JONATHAN T. ROTH, CEDAR FALLS, IA (US)

(73) Assignee: Deere & Company, Moline, IL (US)

(21) Appl. No.: 14/056,567

(22) Filed: Oct. 17, 2013

(51) Int. Cl. B60C 17/06

(52) U.S. Cl. CPC B60C 17/065
USPC 152/158

(57) ABSTRACT

A tire assembly includes a wheel rim, a tire mounted on the rim and a foam insert which only partially fills an annular volume enclosed by the tire and rim. The foam insert displaces air within the annular volume. The insert is not bonded to the tire. The insert maintains its shape and its mass distribution within the tire.

### FIELD

The present disclosure relates to a wheel assembly with foam insert.

### BACKGROUND

A central tire inflation system (CTIS) uses an air compressor to provide pressurized air to all the wheel assemblies on a vehicle, in order to modulate the tire pressure. By displacing the air volume within the wheel and tire assembly, the amount of air that has to be pumped to the wheel and tire assembly in order to increase the tire pressure can be reduced. By reducing the amount or air that is required, the reaction time of the CTIS system can be reduced. Also, the size of compressor required to meet the CTIS pressure change time can be reduced. Also, reducing the time that air is pumped across the rotary axle seals will extend the life of the rotary axle seal. Thus, it is desired to have a tire assembly which reduces CTIS system response time, lengthens axle seal life and permits use of a smaller compressor.

It is known to fill a tire with foam in order to provide a run flat capability. But, this requires that the foam to be in contact with the tire carcass, and the foam therefore effects the normal operation of the tire. In these designs, the foam affects the tire weight and spring rate. This could cause power hop issues, ride control, and customer comfort issues.

### SUMMARY

According to an aspect of the present disclosure, a tire assembly includes a wheel rim, a tire and a foam insert. The tire is mounted on the rim so that the tire and the rim enclose an annular volume. The foam insert only partially fills the annular volume. The foam insert merely displaces air within the annular volume, and is not bonded to the tire.

The tire includes an outer wall and a pair of side walls which connect the outer wall to the rim. In one embodiment the foam insert may engage a radially outer surface of the rim and is spaced apart from an inner surface of the outer wall. In another embodiment, the foam insert may engage an inner surface of the outer wall and is spaced apart from a radially outer surface of the rim. The insert may have a radially outer surface which forms a surface of a cylinder. The insert may have a radially outer surface which has a uniform diameter. The insert may have a radially outer surface which is curved in a cross sectional direction.

The foam insert will displace air volume in the tire to improve the performance of a tire inflation system. By displacing the air volume in the tire, the time required to modulate between pressures is reduced, and consequently rotary seal life is increased. The foam insert is not bonded to the tire, since this would affect the tire deflection properties, and thus affect tire ride and vehicle stability.

### BRIEF DESCRIPTION OF THE DRAWINGS

FIG. 1 is a perspective sectional view of a tire assembly with a first embodiment of the invention;

FIG. 2 is perspective sectional view along lines 2-2 of FIG. 1;

FIG. 3 is a perspective sectional view of a tire assembly with a second embodiment of the invention;

FIG. 4 is a perspective sectional view along lines 4-4 of FIG. 3;

FIG. 5 is a perspective sectional view of a tire assembly with a third embodiment of the invention; and

FIG. 6 is a perspective sectional view along lines 6-6 of FIG. 5.

### DETAILED DESCRIPTION OF THE DRAWINGS

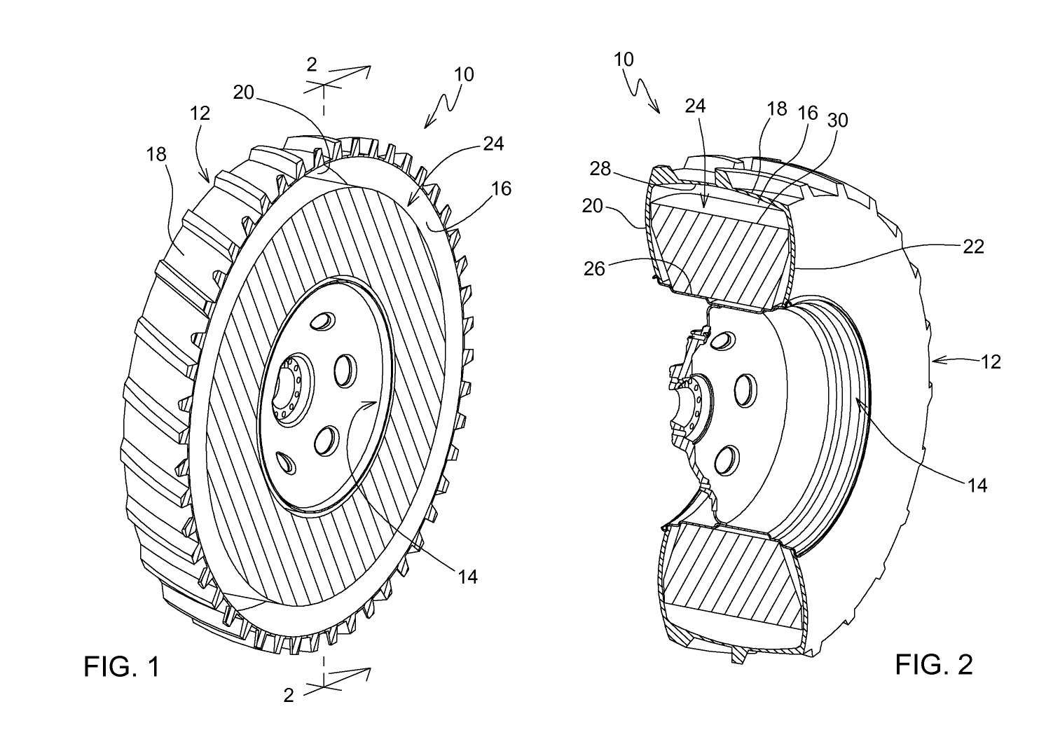

Referring to FIGS. 1 and 2, a tire assembly 10 includes a conventional tire 12 mounted on a convention wheel rim 14. The tire and the rim enclose an annular volume 16. The tire 12 includes an outer wall 18 and a pair of side walls 20 and 22 which connect the outer wall 18 to the rim 14.

A foam insert 24 only partially fills the annular volume 16. The foam insert 24 displaces air within the annular volume 16. Various types of foam material will meet this condition. For example, the foam could be polyethylene closed cell foam in an 8 pound per cubic foot or greater density, or a closed cell blended sponge rubber foam in an 8 pound per cubic foot or greater density, as well as other types.

The insert 24 is not bonded to the tire 12, and maintains its shape and its mass distribution within the tire 12. The foam insert 24 is not fixed to any interior surface of the tire assembly, but is engagable with a radially outer surface 26 of the rim 14 and is spaced apart from an inner surface 28 of the outer wall 18. The insert 24 has a radially outer surface 30 which forms a surface of a cylinder with a uniform diameter.

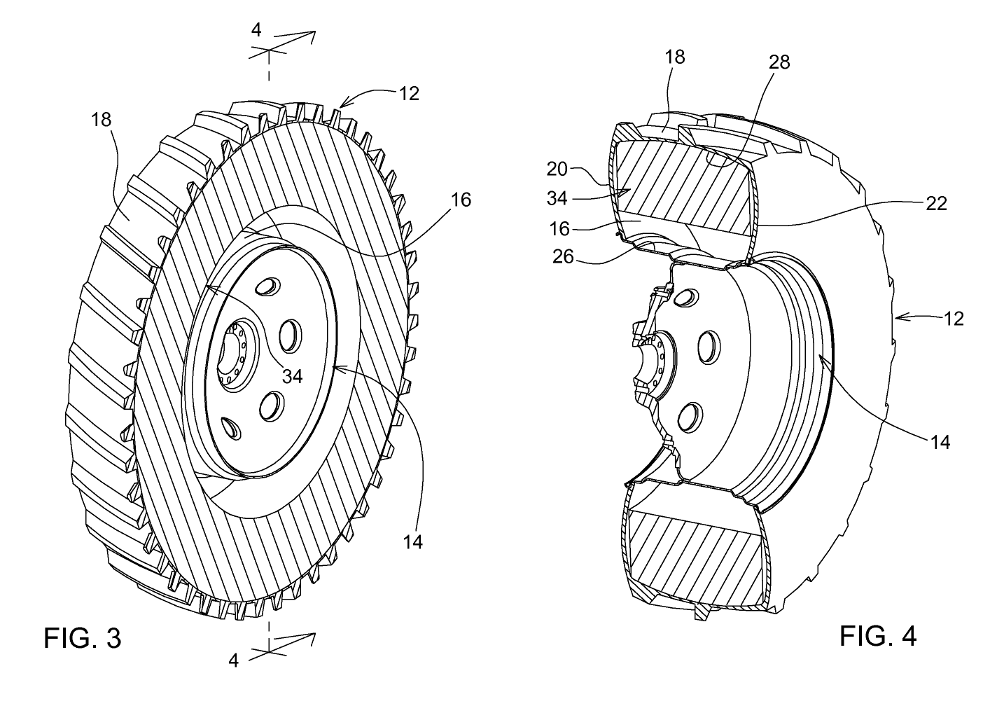

Referring to FIGS. 3 and 4, a foam insert 34 is the same as insert 24, except that insert 34 is permitted to engage the inner surface 28 of the outer wall 18 and is spaced apart from the radially outer surface 26 of the rim 14.

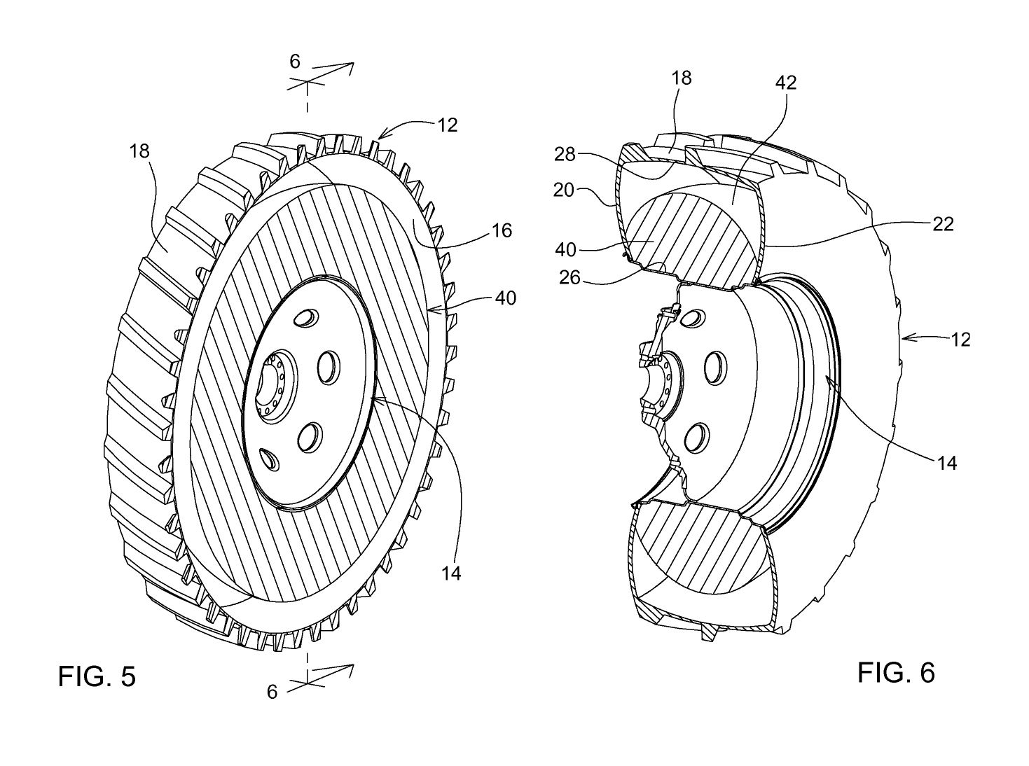

Referring to FIGS. 5 and 6, a foam insert 40 is the same as inserts 24 and 34, except that insert 40 is spaced apart from the inner surface 28 of the outer wall 18.

Insert 40 and is spaced apart from almost all of the side walls 20 and 22. The insert 40 is permitted to engage the radially outer surface 26 of the rim 14 and is permitted to engage a radially inner portion of the side walls 20 and 22. In addition, insert 40 has a radially outer surface 42 which is curved in a cross sectional direction.

The result is a tire assembly which is partially filled with a loose piece of foam which merely displaces air in the tire so that the air volume in the tire is reduced and so that the tire can be more quickly inflated and deflated. The air volume of a wheel and tire assembly is partially filled with the foam material. The foam is inactive and does not change over time. It has very low mass as to not influence the overall mass of the tire. It should not change the spring rate characteristic of the wheel and tire assembly. The material is shaped so that it partially fills up the air volume in within the wheel and tire assembly. Also, the foam material can be removed from the tire for service or repair needs.

While the disclosure has been illustrated and described in detail in the drawings and foregoing description, such illustration and description is to be considered as exemplary and not restrictive in character, it being understood that illustrative embodiments have been shown and described and that all changes and modifications that come within the spirit of the disclosure are desired to be protected. It will be noted that alternative embodiments of the present disclosure may not include all of the features described yet still benefit from at least some of the advantages of such features. Those of ordinary skill in the art may readily devise their own implementations that incorporate one or more of the features of the present disclosure and fall within the spirit and scope of the present invention as defined by the appended claims.

What is claimed is:

1. A tire assembly comprising:
a wheel rim;
a tire mounted on the rim, the tire and the rim enclosing an annular volume; and
a foam insert only partially filing said annular volume, said insert displacing air within the annular volume, said insert not being bonded to the tire, said insert maintaining its shape and its mass distribution within the tire.

2. The tire assembly of claim 1, wherein:
the tire includes an outer wall and a pair of side walls which connect the outer wall to the rim; and
the foam insert engages a radially outer surface of the rim and is spaced apart from an inner surface of the outer wall.

3. The tire assembly of claim 1, wherein:
the tire includes an outer wall and a pair of side walls which connect the outer wall to the rim; and
the foam insert engages an inner surface of the outer wall and is spaced apart from a radially outer surface of the rim.

4. The tire assembly of claim 2, wherein:
the insert has a radially outer surface which forms a surface of a cylinder.

5. The tire assembly of claim 2, wherein:
the insert has a radially outer surface which has a uniform diameter.

6. The tire assembly of claim 2, wherein:
the insert has a radially outer surface which is curved in a cross sectional direction.

7. A tire assembly comprising:
a wheel rim;
a tire mounted on the rim, the tire and the rim enclosing an annular volume, the tire having an outer wall and a pair of side walls which connect the outer wall to the rim; and
a foam insert only partially filing said annular volume, said insert displacing air within the annular volume, said insert not being bonded to the tire, said insert maintaining its shape and its mass distribution within the tire, and the foam insert engaging one of said rim and said outer wall.

8. The tire assembly of claim 7, wherein:
the foam insert engages a radially outer surface of the rim and is spaced apart from an inner surface of the outer wall.

9. The tire assembly of claim 7, wherein:
the foam insert engages an inner surface of the outer wall and is spaced apart from a radially outer surface of the rim.

10. A tire assembly comprising:
a wheel rim;
a tire mounted on the rim, the tire and the rim enclosing an annular volume, the tire having an outer wall and a pair of side walls which connect the outer wall to the rim; and
a foam insert only partially filing said annular volume, said insert displacing air within the annular volume, said insert not being bonded to the tire, said insert maintaining its shape and its mass distribution within the tire, and the foam insert being spaced apart from one of said rim and said outer wall.

11. The tire assembly of claim 10, wherein:
the foam insert engages a radially outer surface of the rim and is spaced apart from an inner surface of the outer wall.

12. The tire assembly of claim 10, wherein:
the foam insert engages an inner surface of the outer wall and is spaced apart from a radially outer surface of the rim.

13. The tire assembly of claim 10, wherein:
the foam comprises a closed cell foam with a density of at least 8 pounds per cubic foot.

14. The tire assembly of claim 13, wherein:
the foam is a polyethylene closed cell foam or a closed cell blended sponge rubber foam.
